(19) United States
(12) Patent Application Publication
(10) Pub. No.: US 2020/0364783 A1
(43) Pub. Date: Nov. 19, 2020

(54) ACCOUNT CYCLE DATE SELECTION AND OPTIMIZATION

(71) Applicant: Capital One Services, LLC, McLean, VA (US)

(72) Inventors: Shane MAZUR, Toronto (CA); Mark YAMASHITA, Toronto (CA)

(73) Assignee: Capital One Services, LLC, McLean, VA (US)

(21) Appl. No.: 16/411,024

(22) Filed: May 13, 2019

(51) Int. Cl. G06Q 40/02; G06N 7/00

(52) U.S. Cl. CPC G06Q 40/025; G06N 7/005

(57) ABSTRACT

The present disclosure provides computing systems and techniques for selection of revolving credit account cycle end dates based on delinquency scoring models. A server can identify a number of optional cycle end dates based on potential cycle end dates based on a cycle date optimization model and credit profile of the account owner. The optional cycle end dates can be the potential cycle end dates having the lowest probability of delinquency based on the model.

### TECHNICAL FIELD

Examples described herein are generally related to account cycle dates or end dates of an account cycle, such as monthly account closing dates. Particularly, the examples relate to selecting and optimizing account cycle dates.

### BACKGROUND

Many accounts, such as, credit account, cycle every set number of days, weeks, or months. The time period between billings is referred to as the cycle where the date on which the account is cycled is referred to as the cycle date. The cycle date is often the date on which interest on the account is accrued and determines the payment date.

### BRIEF DESCRIPTION OF THE DRAWINGS

FIG. 1 illustrates a server.

FIG. 2 illustrates a system.

FIG. 3 illustrates a technique.

FIG. 4 illustrates a logic flow.

FIG. 5 illustrates a logic flow.

FIG. 6 illustrates an example storage medium.

FIG. 7 illustrates an example computer architecture.

### DETAILED DESCRIPTION

The present disclosure provides for the selection of a cycle date based on numerous factors, such as, for example, credit history of the account owner, other account cycle dates of the account owner, past delinquencies, or the like. The present disclosure provides selecting a cycle end date based on a model, such as, for example, a regression model, a neural network model, a pattern classification model, or a decision tree model. In some instances, a number of potential cycle dates can be selected by the model and presented to a user for final selection, or confirmation, of which date the account owner prefers as the cycle end date.

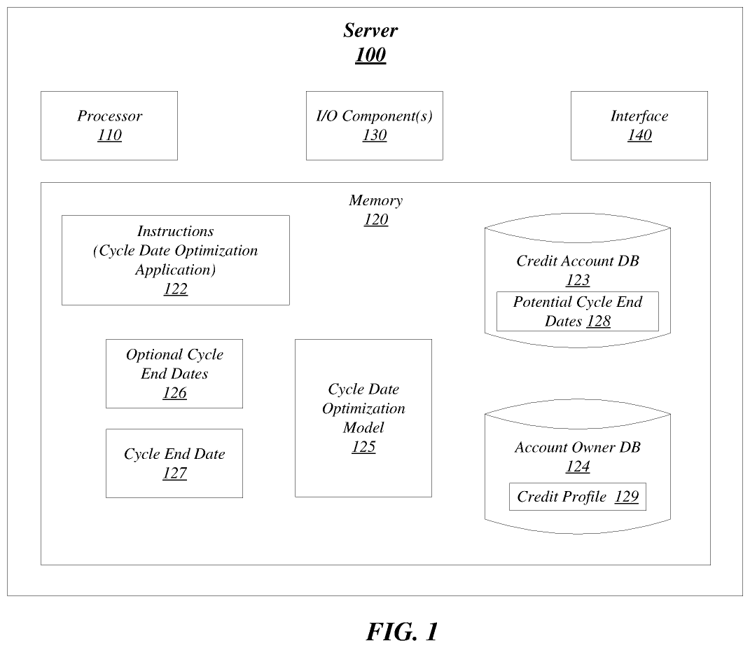

FIG. 1 illustrates an example server 100. The server 100 could be incorporated into a company's backend website services, mobile application services, account review services, account approval services, or the like. In general, server 100 operates to select a cycle end date for a revolving credit account. In some examples, server 100 could be accessible and/or coupled to computing resources (e.g., servers, cloud hosted computing services, etc.) arranged to provide an interface for customer to access revolving account services, such as, establishment and/or review services, with which the customer can select and cycle end date for a revolving account.

The server 100 can include, at least in part, a processor 110, a memory 120, input/output (I/O) component(s) 130, and interface 140. Memory 120 may store instructions 122, which are executable by processor 110. Instructions 122 can correspond to a cycle date optimization application. Memory 120 may further store credit history database (db) 123, account owner db 124, cycle date optimization model 125, optional cycle end dates 126, and cycle end date 127. The credit account db 123 can include a list of potential cycle end dates 128 corresponding to various revolving credit accounts while account owner db 124 can include indications of a credit history 129 of the account owner.

In some examples, credit account db 123 and/or account owner db 124 can be stored on another device, besides server 100. For example, credit account db 123 and/or account owner db 124 can be stored in a memory location (not depicted) accessible to server 100, such as, for example, another server, or the like.

In general, cycle date optimization model 125 can be any of a variety of types of models used to select, a cycle end date for a revolving credit account based on information about the account owner. In some examples, cycle date optimization model 125 can be a logistic regression model, neural network model, a pattern classification model, or a decision tree model.

Responsive to executing instructions 122, server 100 can identify a sub-set of the potential cycle end dates 128 for a revolving credit account. With some examples, the revolving credit account can be a credit card account, an installment loan account, an auto loan account, a recreational vehicle loan account, a watercraft loan account or a mortgage account. Processor 110 can execute instructions 122 to select optional cycle end based in part on cycle date optimization model 125, credit account db 123 and account owner db 124. For example, Processor 110, in executing instructions 122, can execute cycle date optimization model 125 with inputs based on information from credit account db 123 (e.g., potential cycle end dates 128) and account owner db 124 (e.g., credit profile 129) to output optional cycle end dates 126. With some examples, optional cycle end dates 126 can be a listing of the potential cycle end dates and an indication of a probability of delinquency, based on cycle date optimization model 125, for each of the potential cycle end dates 128.

Cycle date optimization model 125 can be arranged to output optional cycle end dates 126, where the optional cycle end dates include less than all of the potential cycle end dates 128. In some examples, the potential cycle end dates 128 can include days 1 through 28 of any given month. In other examples, the cycle end dates can correspond to days 1 through 28 of selected months in a year (e.g., where cycle end dates are quarterly, bi-annually, annually, or the like). Cycle date optimization model 125 can be arranged to receive as input indications of data points related to an owner of the revolving credit account, such as, for example, credit profile 129 information from account owner db 124.

In some examples, credit profile 129 can include indications of a credit score, a credit history metadata, an account type of the revolving credit account, an age, a gender, employment history metadata, and a geographic location of the account owner. As a specific example, credit history metadata included in credit profile 129 can include indications of active account types, active account due dates, and prior delinquencies. As another specific example, employment history metadata included in credit profile 129 can include indications of current employment status, gaps in employment, length at current employer, length in current industry, pay frequency, and income.

Processor 110, in executing instructions 122, can select cycle end date 127 from the optional cycle end dates generated by cycle date optimization model 125. In some examples, optional cycle end dates 126 can include a ranked indication of probability of delinquency. As such, processor 110, in executing instructions 122, can select the one of the optional cycle end dates 126 having the lowest probability of delinquency. In some examples, optional cycle end dates 126 can include a selected number (e.g., 3, 4, 5, 6, 7, etc.) of the potential cycle end dates 128 having the lowest probability of delinquency.

With some examples, the processor 110 may include circuity or processor logic, such as, for example, any of a variety of commercial processors. In some examples, the processor 110 may include multiple processors, a multi-threaded processor, a multi-core processor (whether the multiple cores coexist on the same or separate dies), and/or a multi-processor architecture of some other variety by which multiple physically separate processors are in some way linked. Additionally, in some examples, the processor 110 may include graphics processing portions and may include dedicated memory, multiple-threaded processing and/or some other parallel processing capability.

The memory 120 may include logic, a portion of which includes arrays of integrated circuits, forming non-volatile memory to persistently store data or a combination of non-volatile memory and volatile memory. It is to be appreciated, that the memory 120 may be based on any of a variety of technologies. In particular, the arrays of integrated circuits included in memory 120 may be arranged to form one or more types of memory, such as, for example, dynamic random access memory (DRAM), NAND memory, NOR memory, or the like.

The I/O component(s) 130 may include one or more components to provide input to or to provide output from the server 100. For example, the I/O component(s) 130 may be a keyboard (hardware, virtual, etc.), mouse, joystick, microphone, track pad, button, touch layers of a display, haptic feedback device, camera, microphone, speaker, or the like.

Interface 140 may include logic and/or features to support a communication interface. For example, the interface 140 may include one or more interfaces that operate according to various communication protocols or standards to communicate over direct or network communication links. Direct communications may occur via use of communication protocols or standards described in one or more industry standards (including progenies and variants). For example, the interface 140 may facilitate communication over a bus, such as, for example, peripheral component interconnect express (PCIe), non-volatile memory express (NVMe), universal serial bus (USB), system management bus (SMBus), SAS (e.g., serial attached small computer system interface (SCSI)) interfaces, serial AT attachment (SATA) interfaces, or the like.

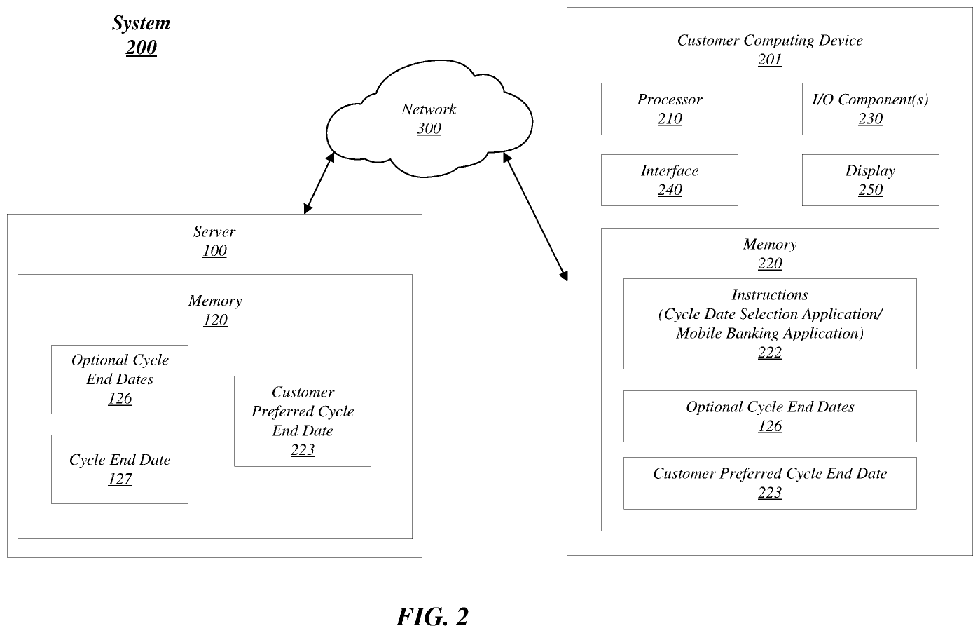

FIG. 2 illustrates an example system 200 including a customer computing device 201 coupled to the server 100 of FIG. 1 via a network 300. Network 300 could be, for example, a local area network (LAN), a wide area network (WAN), or a cellular network (e.g., LTE, 3GPP, or the like). In some embodiments, network 300 could include the Internet.

With some examples, server 100 can be arranged to select cycle end date based in part on information received from an account owner, for example, via customer computing device 201. Customer computing device 201 could be any device arranged to couple to server 100 via network 300. For example, customer computing device 201 could be a smart phone, a tablet computer, a laptop computer, a desktop computer, or the like.

Customer computing device 201 can include, at least in part, a processor 210, a memory 220, I/O component 230, an interface 240, and a display 250. Memory 220 may store instructions 222, which are executable by processor 210. Instructions 222 can correspond to a web browser application used to access account creation and/or review services hosted by server 100 or to access a mobile banking application associated with the revolving credit account for which the cycle end date 127 is being selected. Memory 220 can further store optional cycle end dates 126 and customer preferred cycle end date 223.

During operation, customer computing device 201 can connect to server 100 to select a cycle end date for a revolving credit account. Processor 110, in executing instructions 122, can send an information element to customer computing device 201 including indications of optional cycle end dates 126. For example, optional cycle end dates 126 can be identified as described herein and indications of the optional cycle end dates 126 provided to customer computing device 201. Processor 201, in executing instructions 222, can present the optional cycle end dates 126, for example, on display 250.

Processor 210, in executing instructions 222, can receive an indication of a one of the optional cycle end dates 126, for example, via I/O components 230, or the like. This one of the optional cycle end dates 126 can be stored as customer preferred cycle end date 223. Processor 210, in executing instructions 222, can send an information element to server 100 including an indication of the customer preferred cycle end date 223 to server 100.

Processor 110, in executing instructions 122, can designate the customer preferred cycle end date 223 as the cycle end date 127.

With some examples, the processor 210 may include circuity or processor logic, such as, for example, any of a variety of commercial processors. In some examples, the processor 210 may include multiple processors, a multi-threaded processor, a multi-core processor (whether the multiple cores coexist on the same or separate dies), and/or a multi-processor architecture of some other variety by which multiple physically separate processors are in some way linked. Additionally, in some examples, the processor 210 may include graphics processing portions and may include dedicated memory, multiple-threaded processing and/or some other parallel processing capability.

The memory 220 may include logic, a portion of which includes arrays of integrated circuits, forming non-volatile memory to persistently store data or a combination of non-volatile memory and volatile memory. It is to be appreciated, that the memory 220 may be based on any of a variety of technologies. In particular, the arrays of integrated circuits included in memory 220 may be arranged to form one or more types of memory, such as, for example, dynamic random access memory (DRAM), NAND memory, NOR memory, or the like.

The I/O component(s) 230 may include one or more components to provide input to or to provide output from the customer computing device 201. For example, the I/O component(s) 230 may be a keyboard (hardware, virtual, etc.), mouse, joystick, microphone, track pad, button, touch layers of a display, haptic feedback device, camera, microphone, speaker, or the like.

Interface 240 may include logic and/or features to support a communication interface. For example, the interface 240 may include one or more interfaces that operate according to various communication protocols or standards to communicate over direct or network communication links. Direct communications may occur via use of communication protocols or standards described in one or more industry standards (including progenies and variants). For example, the interface 240 may facilitate communication over a bus, such as, for example, peripheral component interconnect express (PCIe), non-volatile memory express (NVMe), universal serial bus (USB), system management bus (SMBus), SAS (e.g., serial attached small computer system interface (SCSI)) interfaces, serial AT attachment (SATA) interfaces, or the like.

Display 250 can be based on any of a variety of display technologies, such as, for example, a cathode ray tube (CRT), a liquid crystal display (LCD), plasma display, light emitting diode (LED) display, or an organic light emitting diode (OLED) display. With some examples, display 250 can be a touch sensitive display and can include I/O components 230. It is noted, display 250 may be external to the customer computing device 201, such as, for example, embodied as a computer monitor or television and coupled to the customer computing device 201 via any of a variety of display data interfaces.

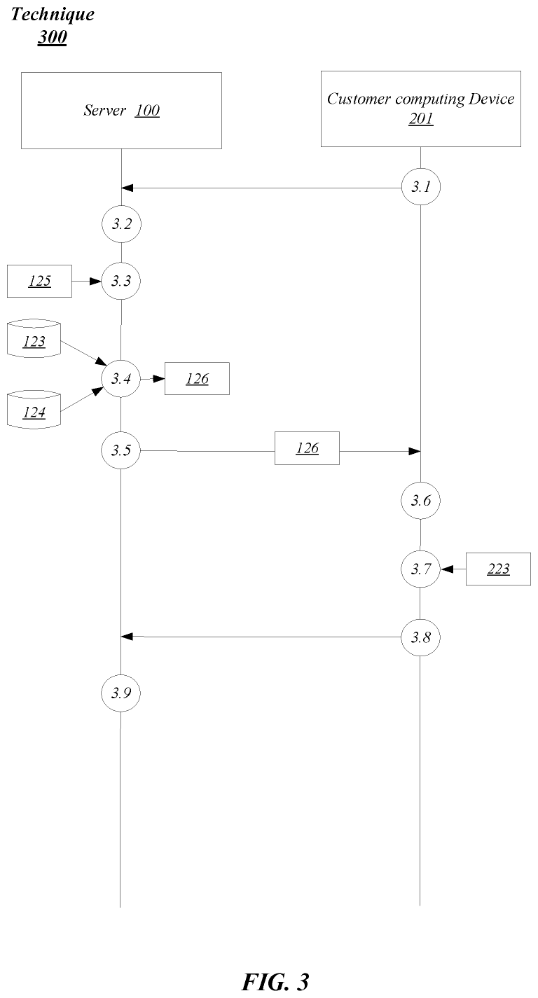

FIG. 3 illustrates a technique 300 to select a cycle end date. Technique 300 is described with reference to the system 200 depicted in FIG. 2. However, technique 300 could be implemented by a system having a different configuration than depicted. Examples are not limited in this context. Technique 300 can begin at circle 3.1. At circle 3.1, customer computing device 201 can send an information element to server 100 including an indication to select a cycle end date for a revolving account. For example, a user can interact with a mobile banking application to select (or change) a cycle end date for a revolving account. The mobile banking application 222, in being executed by processor 210, can send the indication to select the cycle end date to server 100.

Continuing to circle 3.2, server 100 can initiate model based cycle end date selection as described herein. With some examples, circle 3.2, can be responsive to customer computing device 201 sending an information element at circle 3.1. In other examples, circle 3.1, can be optional and technique 300 can being at circle 3.2. In other examples, circle 3.2, can be responsive to an application for a revolving account, an approval of an application for a revolving account, or the like.

Continuing to circle 3.3, server 100 can access cycle date optimization model 125. At circle 3.4 server 100 can generate optional cycle end dates 126 based in part on credit account db 123 and/or account owner db 124. Processor 210, in executing instructions 222, can generate optional cycle end dates 126 from potential cycle end dates 128 and credit profile 129 using cycle end date optimization model 125.

Technique 300 can optionally, include circles 3.5, 3.6, 3.7, and 3.8. At circle 3.5, server 100 can send an information element including an indication of optional cycle end dates 126 to customer computing device 201. At circle 3.6, customer computing device 201 can present an indication of the optional cycle end dates 126 for an account owner (e.g., user of customer computing device 201, or the like). For example, processor 210, in executing instructions 222 can present (e.g., via a graphical user interface on display 250, or the like) indications of optional cycle end dates 126.

At circle 3.7, customer computing device 201 can receive customer preferred cycle end date 223 based in part on a selection of a one of the optional cycle end dates 126. At circle 3.8, customer computing device 201 can send an information element including an indication of customer preferred cycle end date 223 to server 100.

Continuing to circle 3.9, server 100 can set cycle end dates based on customer preferred cycle end date 223. For example, in instances where circles 3.5 to 3.8 are included in technique 300; processor 110, in executing instructions 122, can set cycle end date 127 as the date indicated by customer preferred cycle end date 223. As another example, where circles 3.5 to 3.8 are not included in technique 300; processor 110, in executing instructions 122, can set cycle end date 127 as the one of the optional cycle end dates 126 having the lower probability of delinquency.

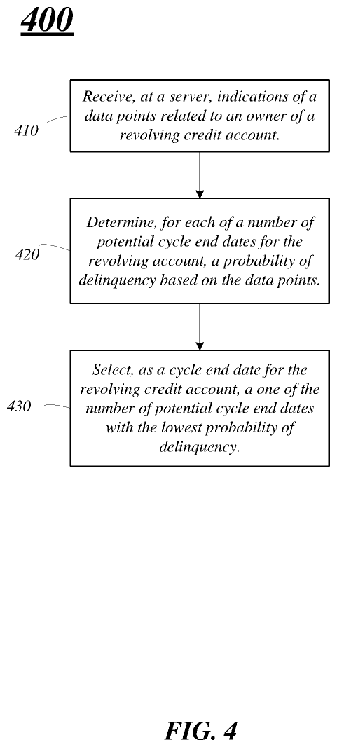

FIG. 4 illustrates a logic flow 400 to select a cycle end date. A server executing a cycle date optimization application can set a cycle end date using logic flow 400. For example, server 100 of FIG. 1 can set cycle end date 127 using logic flow 400. In some implementations, server 100 can use logic flow 400 to set cycle end date 127 as part of technique 300.

Logic flow 400 may begin at block 410. At block 410 “receive, at a server, indications of a data points related to an owner of a revolving credit account” server 100 can receive indication of data points for an account owner of a revolving credit account. For example, server 100 can access account owner db 124 including indications of credit profile 129. For example, processor 110 in executing instructions 122 can access account owner db 124 to access data points indicated by credit profile 129.

Continuing to block 420 “determine, for each of a number of potential cycle end dates for the revolving account, a probability of delinquency based on the data points” server 100 can determine, for each of the potential cycle end dates 128 for the revolving credit account a probability of delinquency. For example, processor 110, in executing instructions 122, can determine, based on credit profile 129 a probability of delinquency for each of potential cycle end dates 118 using cycle date optimization model 125.

Continuing to block 430 “select, as a cycle end date for the revolving credit account, a one of the number of potential cycle end dates with the lowest probability of delinquency” server 100 can select cycle end date 127 as the potential cycle end date 128 having the least probability of delinquency.

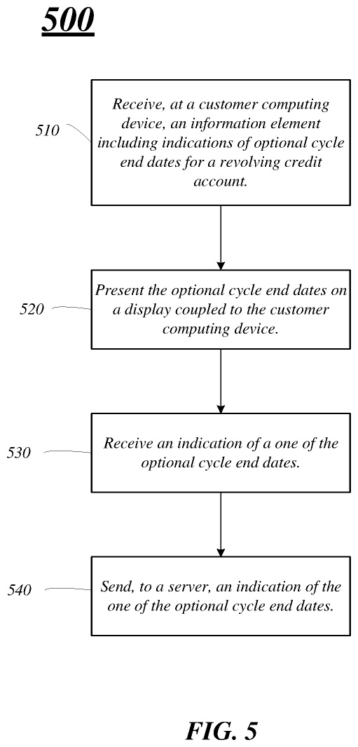

FIG. 5 illustrates a logic flow 500 to select a cycle end date. A customer computing device 201 executing a cycle date selection application (or a mobile banking application) can set a cycle end date using logic flow 500. For example, customer computing device 201 of FIG. 2 can set cycle end date 127 using logic flow 500. In some implementations, customer computing device 201 can use logic flow 500 to set cycle end date 127 as part of technique 300.

Logic flow 500 may begin at block 510. At block 510 “receive, at a customer computing device, an information element including indications of optional cycle end dates for a revolving credit account” customer computing device 201 can receive indications of optional cycle end dates 126. For example, in executing instructions 222, processor 210 can receive an information element indicating optional cycle end dates 126 from server 100.

Continuing to block 520 “present the optional cycle end dates on a display coupled to the customer computing device” customer computing device 201 can present the optional cycle end dates 126 for a user (e.g., revolving credit account owner, or the like). For example, processor 210 in executing instructions 222 can present (e.g., on display 250, or the like) optional cycle end dates.

Continuing to block 530 “receive an indication of a one of the optional cycle end dates” customer computing device can receive an indications of one of the presented optional cycle end dates 126. For example, in executing instructions 222, processor 210 can receive (e.g., via I/O components 230, or the like) an indication of one of the optional cycle end dates and store the indication of customer preferred cycle end date 223.

Continuing to block 540 “send, to a server, an indication of the one of the optional cycle end dates” customer computing device 201 can send an indication of the customer preferred cycle end date 223 to server 100.

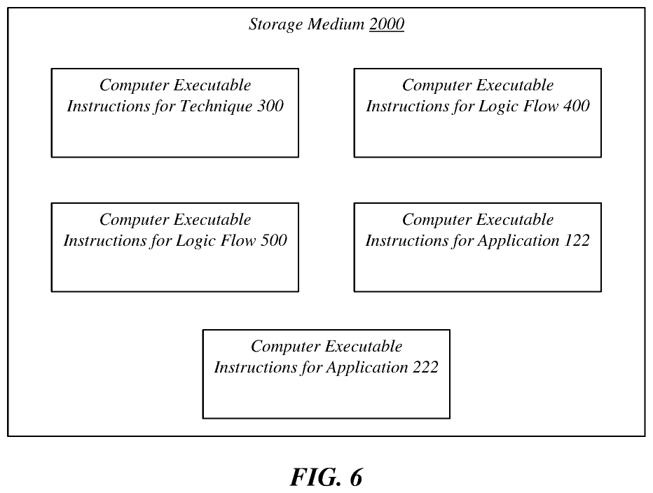

FIG. 6 illustrates an embodiment of a storage medium 2000. Storage medium 2000 may comprise any non-transitory computer-readable storage medium or machine-readable storage medium, such as an optical, magnetic or semiconductor storage medium. In various embodiments, storage medium 2000 may comprise an article of manufacture. In some embodiments, storage medium 2000 may store computer-executable instructions, such as computer-executable instructions to implement one or more of techniques, logic flows, or operations described herein, such as with respect to 300, 400, and/or 500 of FIGS. 3 to 5. The storage medium 2000 may further store computer-executable instructions for applications 122 and/or 222. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable type of code, such as source code, compiled code, interpreted code, executable code, static code, dynamic code, object-oriented code, visual code, and the like. The embodiments are not limited in this context.

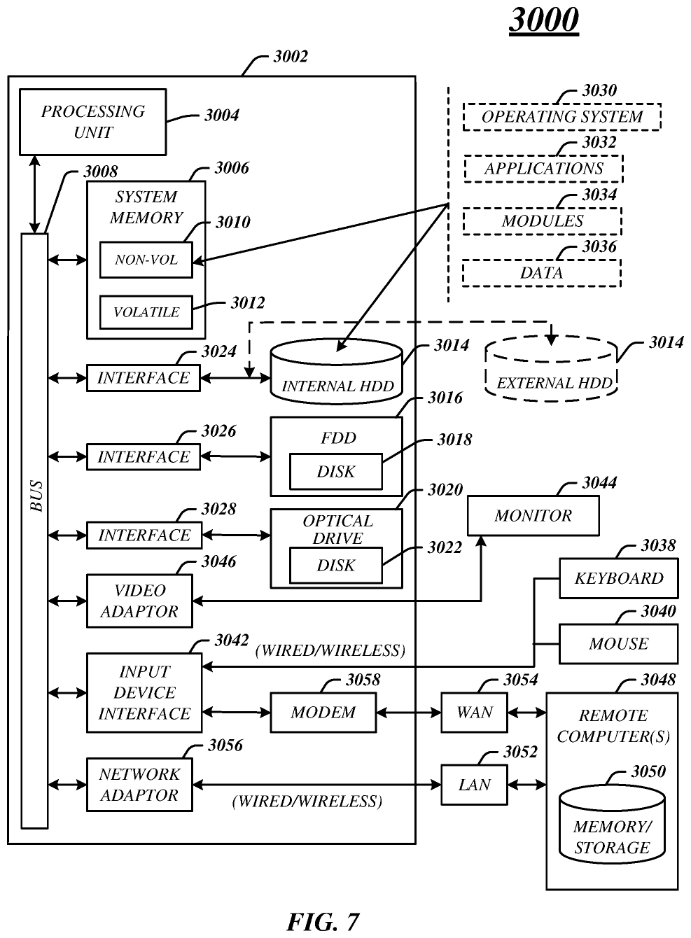

FIG. 7 illustrates an embodiment of an exemplary computing architecture 3000 that may be suitable for implementing various embodiments as previously described. In various embodiments, the computing architecture 3000 may comprise or be implemented as part of an electronic device. In some embodiments, the computing architecture 3000 may be representative, for example, of a computing device that implements one or more components of server 100. The embodiments are not limited in this context.

As used in this application, the terms “system” and “component” and “module” are intended to refer to a computer-related entity, either hardware, a combination of hardware and software, software, or software in execution, examples of which are provided by the exemplary computing architecture 3000. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 3000 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 3000.

As shown in this figure, the computing architecture 3000 comprises a processing unit 3004, a system memory 3006 and a system bus 3008. The processing unit 3004 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 3004.

The system bus 3008 provides an interface for system components including, but not limited to, the system memory 3006 to the processing unit 3004. The system bus 3008 can be any of several types of bus structure that may further interconnect to a memory bus (with or without a memory controller), a peripheral bus, and a local bus using any of a variety of commercially available bus architectures. Interface adapters may connect to the system bus 3008 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The system memory 3006 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory (e.g., one or more flash arrays), polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in this figure, the system memory 3006 can include non-volatile memory 3010 and/or volatile memory 3012. A basic input/output system (BIOS) can be stored in the non-volatile memory 3010.

The computer 3002 may include various types of computer-readable storage media in the form of one or more lower speed memory units, including an internal (or external) hard disk drive (HDD) 3014, a magnetic floppy disk drive (FDD) 3016 to read from or write to a removable magnetic disk 3018, and an optical disk drive 3020 to read from or write to a removable optical disk 3022 (e.g., a CD-ROM or DVD). The HDD 3014, FDD 3016 and optical disk drive 3020 can be connected to the system bus 3008 by a HDD interface 3024, an FDD interface 3026 and an optical drive interface 3028, respectively. The HDD interface 3024 for external drive implementations can include at least one or both of Universal Serial Bus (USB) and IEEE interface technologies.

The drives and associated computer-readable media provide volatile and/or nonvolatile storage of data, data structures, computer-executable instructions, and so forth. For example, a number of program modules can be stored in the drives and memory units 3010, 3012, including an operating system 3030, one or more application programs 3032, other program modules 3034, and program data 3036.

A user can enter commands and information into the computer 3002 through one or more wire/wireless input devices, for example, a keyboard 3038 and a pointing device, such as a mouse 3040. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 3004 through an input device interface 3042 that is coupled to the system bus 3008 but can be connected by other interfaces such as a parallel port, IEEE 994 serial port, a game port, a USB port, an IR interface, and so forth.

A monitor 3044 or other type of display device is also connected to the system bus 3008 via an interface, such as a video adaptor 3046. The monitor 3044 may be internal or external to the computer 3002. In addition to the monitor 3044, a computer typically includes other peripheral output devices, such as speakers, printers, and so forth.

The computer 3002 may operate in a networked environment using logical connections via wire and/or wireless communications to one or more remote computers, such as a remote computer 3048. The remote computer 3048 can be a workstation, a server computer, a router, a personal computer, portable computer, microprocessor-based entertainment appliance, a peer device or other common network node, and typically includes many or all of the elements described relative to the computer 3002, although, for purposes of brevity, only a memory/storage device 3050 is illustrated. The logical connections depicted include wire/wireless connectivity to a local area network (LAN) 3052 and/or larger networks, for example, a wide area network (WAN) 3054. Such LAN and WAN networking environments are commonplace in offices and companies, and facilitate enterprise-wide computer networks, such as intranets, all of which may connect to a global communications network, for example, the Internet.

When used in a LAN networking environment, the computer 3002 is connected to the LAN 3052 through a wire and/or wireless communication network interface or adaptor 3056. The adaptor 3056 can facilitate wire and/or wireless communications to the LAN 3052, which may also include a wireless access point disposed thereon for communicating with the wireless functionality of the adaptor 3056.

When used in a WAN networking environment, the computer 3002 can include a modem 3058, or is connected to a communications server on the WAN 3054, or has other means for establishing communications over the WAN 3054, such as by way of the Internet. The modem 3058, which can be internal or external and a wire and/or wireless device, connects to the system bus 3008 via the input device interface 3042. In a networked environment, program modules depicted relative to the computer 3002, or portions thereof, can be stored in the remote memory/storage device 3050. It will be appreciated that the network connections shown are exemplary and other means of establishing a communications link between the computers can be used.

The computer 3002 is operable to communicate with wire and wireless devices or entities using the IEEE 802 family of standards, such as wireless devices operatively disposed in wireless communication (e.g., IEEE 802.16 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

1. An apparatus, comprising:
a processor; and
a memory coupled to the processor, the memory comprising a cycle date optimization model and instructions executable by the processor, the instructions when executed by the processor cause the processor to:
query a database for indications of a plurality of data points related to an owner of a revolving credit account;
receive, from the database, indications of the plurality of data points related to the owner of the revolving credit account, the revolving credit account having a plurality of potential cycle end dates;
execute the cycle date optimization model to determine, for each of the plurality of potential cycle end dates, a probability of delinquency based on the plurality of data points, wherein the cycle date optimization model is a regression model, a logistic regression model, a neural network model, a pattern classification model, or a decision tree model;
identify as optional cycle end dates a sub-set of the plurality of potential cycle end dates having the lowest probability of delinquency, where the sub-set of the plurality of potential cycle end dates includes less than all of the plurality of potential cycle end dates;
send, to a customer computing device, an information element comprising indications of the optional cycle end dates, the customer computing device to present the optional cycle end dates on a display of the customer computing device and receive an indication of a one of the optional cycle end dates from a user;
receive, from the customer computing device, an indication of the one of the optional cycle end dates as a desired cycle end date; and
designate, as a cycle end date for the revolving credit account, the desired cycle end date.

2. (canceled)

3. The apparatus of claim 1, the memory further comprising instructions that when executed by the processor cause the processor to identify five of the plurality of potential cycle end dates having the lowest probability of delinquency as the sub-set of the plurality of potential cycle end dates.

4. The apparatus of claim 1, wherein the plurality of potential cycle end dates include days 1 through 28 of any given month.

5. The apparatus of claim 1, wherein the revolving credit account is a credit card account, an installment loan account, an auto loan account, a recreational vehicle loan account, a watercraft loan account or a mortgage account.

6. (canceled)

7. The apparatus of claim 1, wherein the plurality of data points comprises at least one of a credit score, a credit history metadata, an account type of the revolving credit account, an age, a gender, employment history metadata, and a geographic location of an account owner.

8. The apparatus of claim 7, wherein the credit history metadata comprises at least one of active account types, active account due dates, and prior delinquencies.

9. The apparatus of claim 7, wherein the employment history metadata includes current employment status, gaps in employment, length at current employer, length in current industry, pay frequency, and income.

10. At least one machine-readable storage medium comprising instructions that when executed by a processor, cause the processor to:
query a database for indications of a plurality of data points related to an owner of a revolving credit account;
receive, from the database, indications of the plurality of data points related to the owner of the revolving credit account, the revolving credit account having a plurality of potential cycle end dates;
execute a cycle date optimization model to determine, for each of the plurality of potential cycle end dates, a probability of delinquency based on the plurality of data points, wherein the cycle date optimization model is a regression model, a logistic regression model, a neural network model, a pattern classification model, or a decision tree model;
identify as optional cycle end dates a sub-set of the plurality of potential cycle end dates having the lowest probability of delinquency, where the sub-set of the plurality of potential cycle end dates includes less than all of the plurality of potential cycle end dates;
send, to a customer computing device, an information element comprising indications of the optional cycle end dates, the customer computing device to present the optional cycle end dates on a display of the customer computing device and receive an indication of a one of the optional cycle end dates from a user;
receive, from the customer computing device, an indication of the one of the optional cycle end dates as a desired cycle end date; and
designate, as a cycle end date for the revolving credit account, the desired cycle end date.

11. (canceled)

12. The at least one machine-readable storage medium of claim 10, comprising instructions that when executed by the processor further cause the processor to identify five of the plurality of potential cycle end dates having the lowest probability of delinquency as the sub-set of the plurality of potential cycle end dates.

13. The at least one machine-readable storage medium of claim 10, wherein the plurality of potential cycle end dates include days 1 through 28 of any given month.

14. The at least one machine-readable storage medium of claim 10, wherein the revolving credit account is a credit card account, an installment loan account, an auto loan account, a recreational vehicle loan account, a watercraft loan account or a mortgage account.

15. (canceled)

16. The at least one machine-readable storage medium of claim 10, wherein the plurality of data points comprises at least one of a credit score, a credit history metadata, an account type of the revolving credit account, an age, a gender, employment history metadata, and a geographic location of an account owner.

17. The at least one machine-readable storage medium of claim 16, wherein the credit history metadata comprises at least one of active account types, active account due dates, and prior delinquencies.

18. The at least one machine-readable storage medium of claim 16, wherein the employment history metadata includes current employment status, gaps in employment, length at current employer, length in current industry, pay frequency, and income.

19. A method comprising:
querying a database for indications of a plurality of data points related to an owner of a revolving credit account;
receiving from the database, at a processor, indications of the plurality of data points related to the owner of the revolving credit account, the revolving credit account having a plurality of potential cycle end dates;
executing, by the processor, a cycle date optimization model to determine, for each of the plurality of potential cycle end dates, a probability of delinquency based on the plurality of data points, wherein the cycle date optimization model is a regression model, a logistic regression model, a neural network model, a pattern classification model, or a decision tree model;
identifying as optional cycle end dates a sub-set of the plurality of potential cycle end dates having the lowest probability of delinquency, where the sub-set of the plurality of potential cycle end dates includes less than all of the plurality of potential cycle end dates;
sending, to a customer computing device, an information element comprising indications of the optional cycle end dates, the customer computing device to present the optional cycle end dates on a display of the customer computing device and receive an indication of a one of the optional cycle end dates from a user;
receiving, from the customer computing device, an indication of the one of the optional cycle end dates as a desired cycle end date; and
designating, as a cycle end date for the revolving credit account, the desired cycle end date.

20. (canceled)

21. The method of claim 19, wherein the revolving credit account is a credit card account, an installment loan account, an auto loan account, a recreational vehicle loan account, a watercraft loan account or a mortgage account.

22. (canceled)

23. The method of claim 19, comprising identifying five of the plurality of potential cycle end dates having the lowest probability of delinquency as the sub-set of the plurality of potential cycle end dates, wherein the plurality of potential cycle end dates include days 1 through 28 of any given month.

24. The method of claim 19, wherein the plurality of data points comprises at least one of a credit score, a credit history metadata, an account type of the revolving credit account, an age, a gender, employment history metadata, and a geographic location of an account owner.

25. The apparatus of claim 1, the memory further comprising instructions that when executed by the processor cause the processor to receive, from the customer computing device, an indication to establish the cycle end date as part of establishment of the revolving credit account or as part of a review of the revolving credit account.

26. The at least one machine-readable storage medium of claim 10, comprising instructions that when executed by the processor further cause the processor to receive, from the customer computing device, an indication to establish the cycle end date as part of establishment of the revolving credit account or as part of a review of the revolving credit account.
